(19) United States
(12) Patent Application Publication
(10) Pub. No.: US 2004/0161580 A1
(43) Pub. Date: Aug. 19, 2004

(54) Inflatable, disposable hygienic protection for toilet seats

(76) Inventor: Sanja Schiller, Melano (CH)

Correspondence Address: YOUNG & THOMPSON, 745 SOUTH 23RD STREET 2ND FLOOR, ARLINGTON, VA, 22202

(21) Appl. No.: 10/776,219

(22) Filed: Feb. 12, 2004

(30) Foreign Application Priority Data
Feb. 17, 2003 (CH) 00238/03

(51) Int. Cl. B32B 3/02

(52) U.S. Cl. 428/66.7; 428/64.1

(57) ABSTRACT

Said protective device consists of two basically oval rings (1) made of soft plastic that are placed one on top of the other and are bonded together (2), and a plastic check valve (3) for inflating the device by blowing air into the ring, thereby turning it into a soft cushion with a point marked on the edge (4) that makes it possible to deflate the cushion-ring after use.

The plastic cushion-ring is inflated by blowing air into the ring through a check valve (which can be pushed into the cushion-ring after this operation). Once inflated and placed on the toilet seat, this cushion-ring provides reliable hygienic protection between the user's body and the toilet seat.

Safety, softness, and elasticity are ensured due to the use of materials such as low-density plastic (LDPE) and vinyl or natural latex. This material makes the device simple and economical to manufacture and handle. The disposable system ensures a high level of hygienic protection for daily needs (once used, the cushion-ring is deflated by pushing on the point that is marked and is disposed of).

The present intervention pertains to a disposable hygienic protective device for toilet seats for daily needs.

In particular, it refers to a kind of protective device made of plastic (LDPE) with the addition of other materials (vinyl and/or latex).

The existing kinds of hygienic protective devices known to date are few in number, and they have the disadvantage of being rigid and difficult to transport or are mechanical (they involve changing a plasticized layer placed directly on the seat of the toilet bowl by pushing a button) and are inherently subject to repeated wear and tear.

This invention is intended to be a simple and safe (disposable) kind of hygienic protection that can always be carried by hand. It is especially suitable for public restrooms (public toilets, hotels, motels, roadside restaurants, cafeterias, movie theaters, hospitals) and for people who have problems using these public facilities (children, senior citizens, invalids), but also for people who desire guaranteed hygienic safety.

The protective device in question consists of two rings made of low-density plastic (LDPE) that are basically oval in shape, are placed one directly on top of the other, and are connected by a bond. The basically oval shape is dictated by the shape of the seat of the toilet bowl.

The ring is equipped with a plastic valve, whose purpose is to inflate the ring into a small cushion. This cushion-ring is thus filled with a certain quantity of air. When placed on the seat of the toilet bowl, it forms a hygienic barrier between the seat and the body of the user.

The valve is located on the oval, so it does not cause any inconvenience for the users of this invention.

The cushion-ring is inflated by blowing into the appropriate aperture on the plastic valve. Three or four strong puffs by an adult will adequately inflate the cushion-ring. Once the aperture on the valve is closed, which can be pushed into of the cushion-ring with the appropriate stopper, the air contained within serves to keep the toilet bowl seat from coming into physical contact with the body of the user. At the same time, when inflated in this way, the cushion-ring guarantees soft and reliable contact between the user's body and the toilet seat.

This cushion-ring has the advantage, owing to its very compact basic dimensions, that it can be easily stored and carried by hand at any time (it is folded and comes in individual packages the size of a sanitary napkin). In addition, it provides unique hygienic protection owing to the fact that the system is disposable. Once the cushion-ring is used, it can be deflated by releasing the air contained in it by pulling on the appropriate spot indicated on the edge of the device.

### DRAWINGS

FIG. 1 shows a schematic top view of the disposable hygienic protective device (cushion-ring);

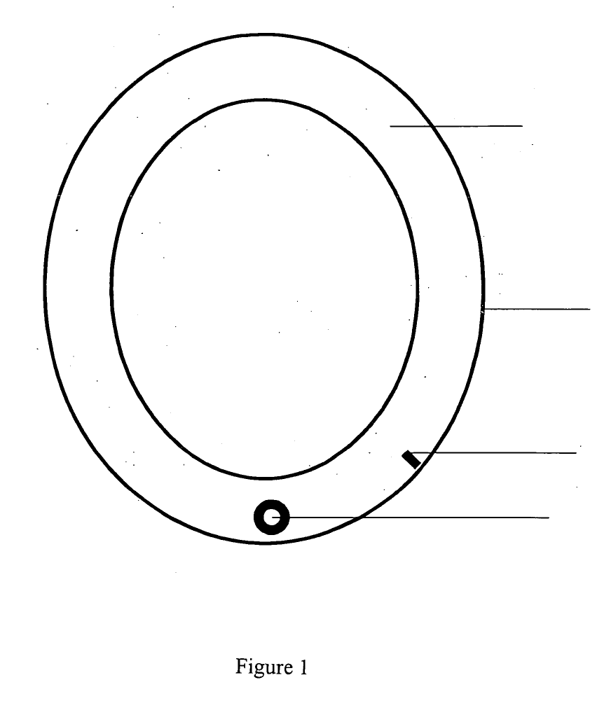

FIG. 2 shows a schematic top view and a side view of the disposable hygienic protective device (cushion-ring).

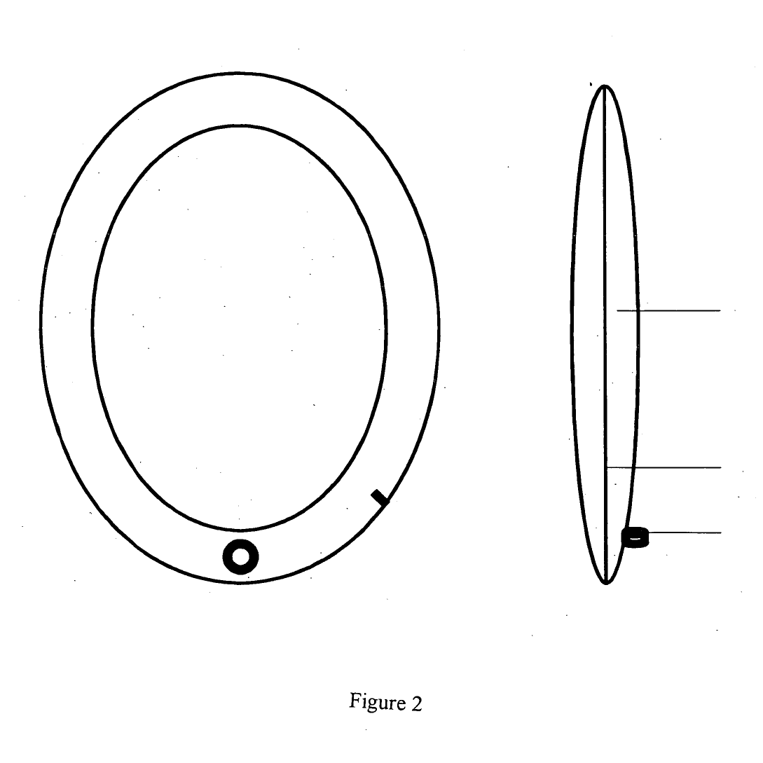

By way of example, referring to the figures, the disposable hygienic protective device for toilet seats that is the object of this invention comprises two soft plastic rings that are placed one exactly on top of the other 1 and are connected by a bond 2, a plastic check valve 3, and a tear-away tab marked on the edge 4.

The disposable hygienic protective device for toilet seats of the example (cushion-ring)—1—is made of soft, low-density plastic (LDPE) that is light in weight and is approximately 15-20 microns thick, thus giving it the required softness. The addition of vinyl to the base plastic imparts elasticity, flexibility, and surface adherence.

Natural latex can be used as an alternative to vinyl, but it should be kept in mind that the use of natural latex may be contraindicated for individuals who are allergic to this material.

The check valve for inflating the cushion-ring 3 is made of plastic.

The materials that are used for the production of this device are all inexpensive and ensure that the cost of the product itself will be low.

1) Disposable hygienic protective device (1) for toilet seats, characterized by the fact that said protective device is made of low-density plastic (LDPE) and optionally vinyl and/or latex.

2) Disposable hygienic protective device (1) for toilet seats according to claim 1, wherein said hygienic protective device is composed of two basically oval rings that are placed one on top of the other and are bonded together (2).

3) Disposable hygienic protective device (1) for toilet seats according to claim 1 or 2, wherein said protective device is inflatable and can be equipped with a check valve (3) made of plastic.

4) Disposable hygienic protective device (1) for toilet seats according to claim 3, wherein, once said protective device is inflated, it can be placed on the toilet seat in order to provide hygienic protection to keep the user's body from coming into direct contact with the toilet seat and wherein it has a tear-away tab (4) marked at the edge to allow it to be deflated after use.

5) Disposable hygienic protective device (1) for toilet seats according to one of claims 1-4, wherein said protective device can be folded up and can be made to be carried in a pocket.
